(19) United States
(12) Patent Application Publication
(10) Pub. No.: US 2015/0288416 A1
(43) Pub. Date: Oct. 8, 2015

(54) Wireless Communication Synchronization System

(71) Applicant: Broadcom Corporation, Irvine, CA (US)

(72) Inventors: Jason Matthew Goldberg, Campbell, CA (US); Emre Tapucu, San Jose, CA (US)

(21) Appl. No.: 14/319,909

(22) Filed: Jun. 30, 2014

Related U.S. Application Data
(60) Provisional application No. 61/975,309, filed on Apr. 4, 2014.

(51) Int. Cl. H04B 1/7073; H04L 7/00

(52) U.S. Cl. CPC H04B 1/70735; H04L 7/0033

(57) ABSTRACT

Wireless communication synchronization at a wireless signal receiver is described. A wireless signal received may be a spread spectrum signal containing a periodic extension of a primary code, a periodic extension of a secondary code, and a data portion. The receiver may determine a first chip sequence representative of the secondary code by extraction of the primary code and the data portion from a first received wireless signal. The receiver may further determine, from a second received wireless signal, a second chip sequence representative of the secondary code by extraction of the primary code from the second received wireless signal. The receiver may identify a phase offset associated with the received wireless signals by analyzing the first chip sequence and the second chip sequence.

### CROSS REFERENCE TO RELATED APPLICATIONS

This application claims priority to provisional application Ser. No. 61/975,309, filed Apr. 4, 2014, which is incorporated by reference in its entirety.

### TECHNICAL FIELD

This disclosure relates to wireless code synchronization, including wireless code synchronization for global navigation satellite systems (GNSS).

### BACKGROUND

Typical digital communication systems involve using a transmitter to send a bit stream to a receiver. The bit stream contains digital information that the receiver decodes and makes use of. In some communications systems, the digital information is extracted by first converting the analog representation of the bit stream to digital samples. Each sample represents the signal at the time of sampling. Because of noise and other effects, signal transitions may not be cleanly represented.

Such digital communication can be used in different systems, such as a Global Navigation Satellite System (GNSS). GNSS is a satellite system that involves a network of satellites in space. Each satellite wirelessly transmits coded signals at precise intervals. A receiver analyzes the signal information to determine position, velocity, and time estimates. The GNSS signal is used for various applications such as to determine the geographic location of a user's receiver anywhere in the world. Using the information in the transmitted signal, the receiver on or near the earth's surface can calculate the exact position of the transmitting satellite and the distance (from the transmission time delay) between the satellite and the receiver. For accurate operation of a system based on receipt of GNSS signals, the transmitting satellite and the receiver are time synchronized.

GNSS are especially sensitive because the GNSS signals are communicated between satellites above the earth's atmosphere and receivers on the earth's surface. In addition, the signals transmitted to the receiver are generated by the transmitter and therefore synchronized to the time base in the transmitter. Thus, the signals are not synchronized to the receiver's time base, and therefore the location of bit transitions in the receiver's time base cannot be assumed.

### BRIEF DESCRIPTION OF THE DRAWINGS

FIG. 1 shows an example communication system that benefits from wireless code synchronization.

FIG. 2 illustrates composition of an example signal used during wireless code synchronization.

FIG. 3 illustrates an example signal receiver.

FIG. 4 illustrates an example flowchart with at least some of the steps involved in the detection of a code phase offset.

### DETAILED DESCRIPTION

The discussion below makes reference to the accompanying drawings which show, by way of illustration, specific embodiments, described in this document. Other embodiments may be utilized and structural changes may be made without departing from the scope of the present document. Further, embodiments are described in context of a Global Navigation Satellite System (GNSS), however the features described in the embodiments may be applicable to other areas of digital communication using spread spectrum signals, such as wireless communications using Code Division Multiple Access (CDMA). The embodiments may be beneficial for accurate and computationally efficient code phase synchronization of spread spectrum signals, such as GNSS signals, in the presence of frequency uncertainty. For example, the techniques presented may be used during the synchronization of secondary codes such as those present in modern GNSS constellations like Beidou and Galileo. Since the code phase synchronization described is computationally efficient, less processing power within system is needed in association with receipt of communications, and can therefore be allocated to other functionality. In the example of GNSS, if, for example, the GNSS is being implemented with application specific integrated circuits on one or more microchips, the communication portion of the GNSS may not only have lower computational needs, but also consume less of the resources of the microchip(s).

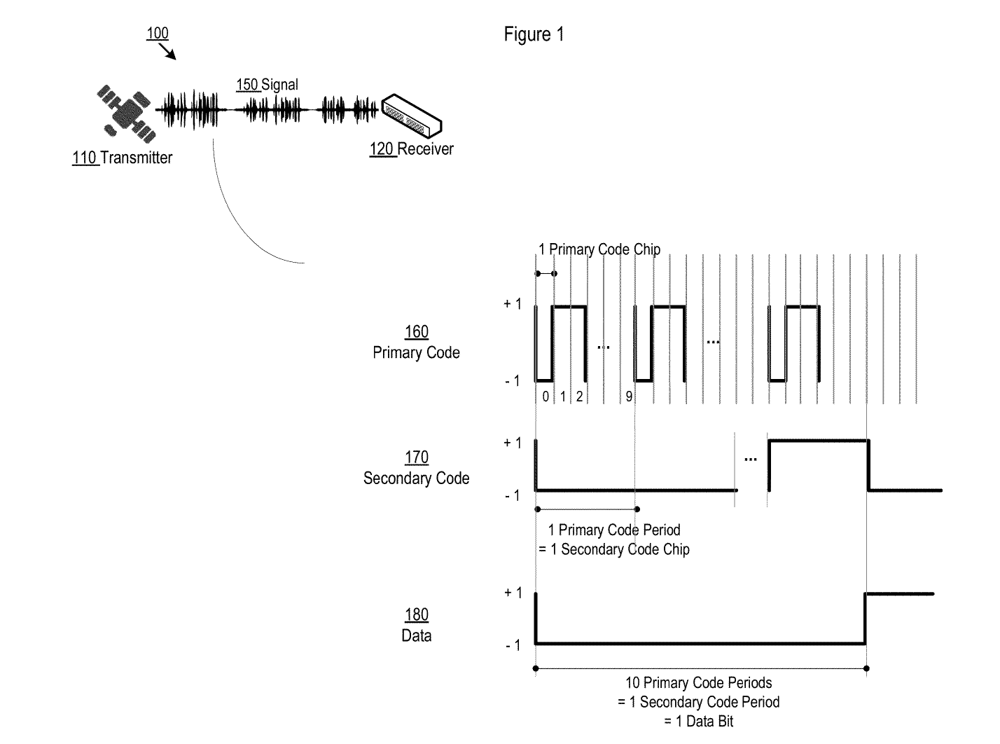

FIG. 1 shows an example communication system 100 in which a transmitter 110 transmits a signal 150 which is received by a receiver 120. Although, FIG. 1 illustrates only one transmitter 110 and one receiver 120, more than one transmitter 110 may communicate with more than one receiver 150 in other examples. For purposes of illustration, the description that follows focuses on communication by a single transmitter to a single receiver. FIG. 1 further illustrates components of the signal 150, including a Primary Code 160, a Secondary Code 170, and a data portion 180. In other examples the signal 150 may not include a data portion 180. The receiver 120 may receive a combination of signals such that some received signals contain data while some signals do not contain a data portion. Each signal component may be of a different periodicity but have a phase relation with each other.

The transmitter 110 may transmit the signal 150 at a fixed rate. The transmitter 110 may also transmit the signal 150 arbitrarily based on a triggering event, such as receipt of an instruction to transmit data. The transmitter 150 may be a satellite, or at a satellite, such as a Global Position Satellite (GPS), in which case the transmitter 110 may transmit the signal 150 continuously at a given rate. Alternatively, the signal 150 may be transmitted by a pseudolite, or a pseudo-satellite, such as a ground-based signal transmission system. The transmitter 110 may be stationary, or moving when transmitting the signal 150.

The transmitter 110, such as a satellite, may be designed to transmit the wireless signal 150, as a spread-spectrum radio signal. The examples described further use a satellite in the role of the transmitter 110, however the transmitter may be any other transmitting devices such as a wireless signal tower or a repeating station that may repeat a received signal. The satellite may include a modulator that uses Phase-shift keying (PSK) as a digital modulation scheme to convey the data 180 by changing, or modulating, the phase of a carrier wave. PSK uses a finite number of phases, each assigned a unique pattern of binary digits. Usually, each phase encodes an equal number of bits. Each pattern of bits forms a symbol that is represented by the particular phase. A demodulator, such as the receiver 120, determines the phase of the received signal and maps it back to the symbol it represents, thus recovering the original data. The receiver 120 may be designed specifically for the symbol-set used by the modulator. Thus, the wireless signal 150 may have at least three parts, or components described later. In addition to the three components, examples of the wireless signal 150 may include other components that benefit from embodiments described.

The wireless signal 150 may have a data 180 portion. The data 180 may contain information necessary for the navigation, such as time and ephemeris data of the satellite. The data 180, may be a binary-coded message containing values that are herein referred to as “+A” and “−A.” The message may be transmitted at a low frequency rate and may provide the navigation information. The value of +A can be 1 and the value of −A can be −1 or 0. The carrier wave may be modulated by the date portion 180 during transmission of the signal 150.

The signal 150 may further have a primary code 160. The primary code 160 may be a ranging code containing a relatively long known sequence of values that are herein referred to as “+B” and “−B.” The value of +B can be a value of 1 and −B can be a value of −1. The transmitter 110 may modulate the carrier wave using the primary code. The primary code 160 may be specific to the satellite and transmitted at higher rate than the data 180. The primary code 160, also called pseudo-random noise (PRN) code, allows precise ranging so that multiple satellites, or transmitters, can broadcast signals at the same frequencies, which can be deciphered using CDMA technology. Typically, the values of the PRN codes are called ‘chips’ instead of ‘bits’, to emphasize that they do not carry information, unlike bits of data 180.

The wireless signal 150 may further include a secondary code 170, which may also be a PRN code. The secondary code 170 is, as indicated by its name, a second code, which multiplies the primary code 160 to form a longer code (called tiered code). The chipping rate of the secondary code 170 is, typically, lower than that of the primary code 160. The values of the secondary code may also be referred to as ‘chips’, since they do not carry data. In FIG. 1, the length of one chip of the secondary code 170 is shown equal to one period of the primary code 160. Any other relation between the rates of the primary code 160 and secondary code 170 is possible. For example, in another embodiment, one period of the primary code 160 may equate to two chips of the secondary code 170. The secondary code 170 is typically used to acquire very weak signals, such as in indoor or urban environments. The secondary code 170 may be a shorter code than the primary code 160. The carrier wave is further modulated using the secondary code 170 during transmission of the signal 150.

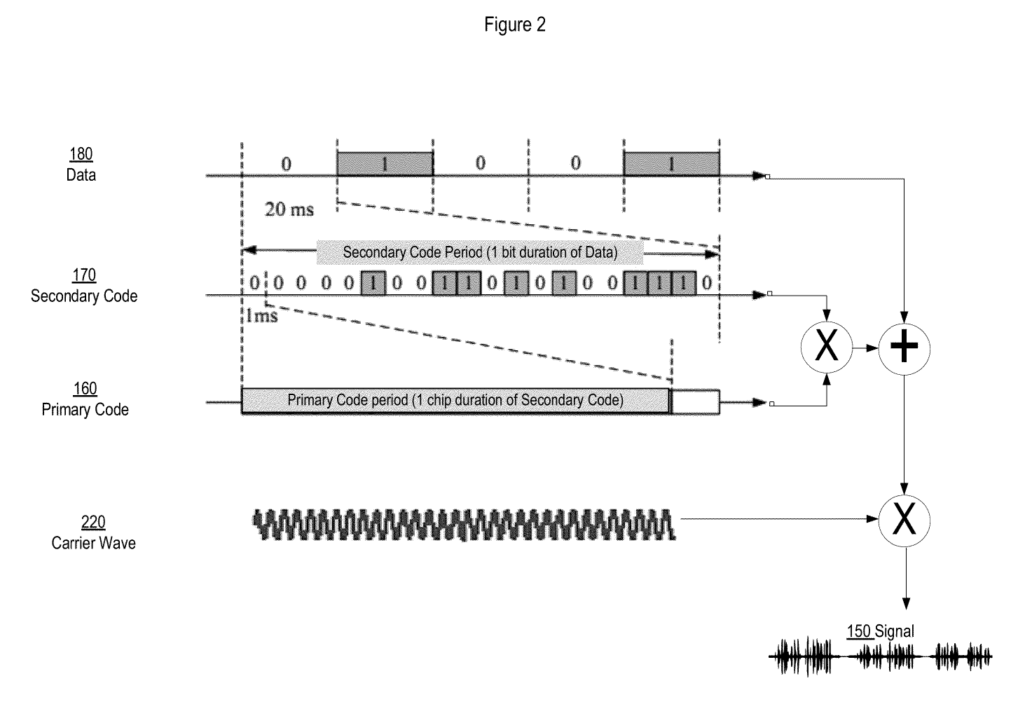

FIG. 2 illustrates an example composition of the signal 150, such as a GNSS signal received by a receiver 120, such as a GNSS receiver. A carrier wave 220, such as a 1575.42 MHz L1 carrier or a 1227.6 MHz L2 carrier may be modulated using various components to obtain the signal 150. For example, in an example GNSS, the carrier wave 220 may be modulated using PSK based on the data 180, the primary code 160, and the secondary code 170. For example, in an embodiment, the primary code 160, also referred to as a C/A (Coarse Acquisition) code sequence may have a transmission signal rate (or chip rate) of 1.023 MHz and a code length of 1023 (i.e., 1 period=1 millisecond). The data bits may be 20 milliseconds long and synchronized to the primary code 160. One of the 1 ms periods in each 20 ms period is selected by the transmitting satellite as the beginning of a data period. Further, each 20 ms data bit may be additionally modulated by the secondary code 170. For example, as shown in FIG. 2, the secondary code 170 may be a 20-symbol (or 20-chip) Neimann-Hoffman code (0, 0, 0, 0, 0, 1, 0, 0, 1, 1, 0, 1, 0, 1, 0, 0, 1, 1, 1, 0). The components may be used to modulate the carrier wave 220 using different combinations. For example, as shown in FIG. 2, the primary code 160 may be multiplied by the secondary code 170 and the resulting product (ranging code) and the data bits may be summed. The multiplication and addition may be performed using modulo 2 values. Alternatively, the primary code 160 either multiplication or modulo 2 addition may be performed. The result of the sum may then be modulated onto the carrier wave using Binary Phase Shift Keying (BPSK) to generate the signal 150 that may be transmitted. The signal 150 may contain periodic extensions of the primary code sequence and the secondary code sequence along with the data. The code sequence may be a sequence of chips. The number of chips in the secondary code may be less than a number of chips in the primary code, and in some examples substantially lesser. For example, the number of chips in a primary code sequence may be 1023, while the number of chips in a secondary code sequence may be 20.

The receiver 120 may search for the presence of signals, such as the signal 150, that travel through space, and try to synchronize with the signals identified from a corresponding transmitter. For example, a GNSS receiver may be a radio navigation user device that identifies and synchronizes with satellite transmitting GNSS signals, so as to demodulate and extract the measurements and navigation information in the received GNSS signals. Since the signal 150 is phase shifted, the receiver 120 may reconstruct the carrier wave 220 and extract the codes and navigation data 180 from the received signal 150. The receiver 120 is designed to be able to determine a shift in the phase of the received signal 150 relative to the transmitted signal. In addition, the receiver 120 may detect and determine the phase offset in the presence of a frequency uncertainty. In another example, the receiver 120 may additionally, or alternatively determine a frequency offset in the received signal 150 relative to the transmitted signal. The phase offset and the frequency offset may be used to synchronize the wireless signal receiver with the transmitter 110.

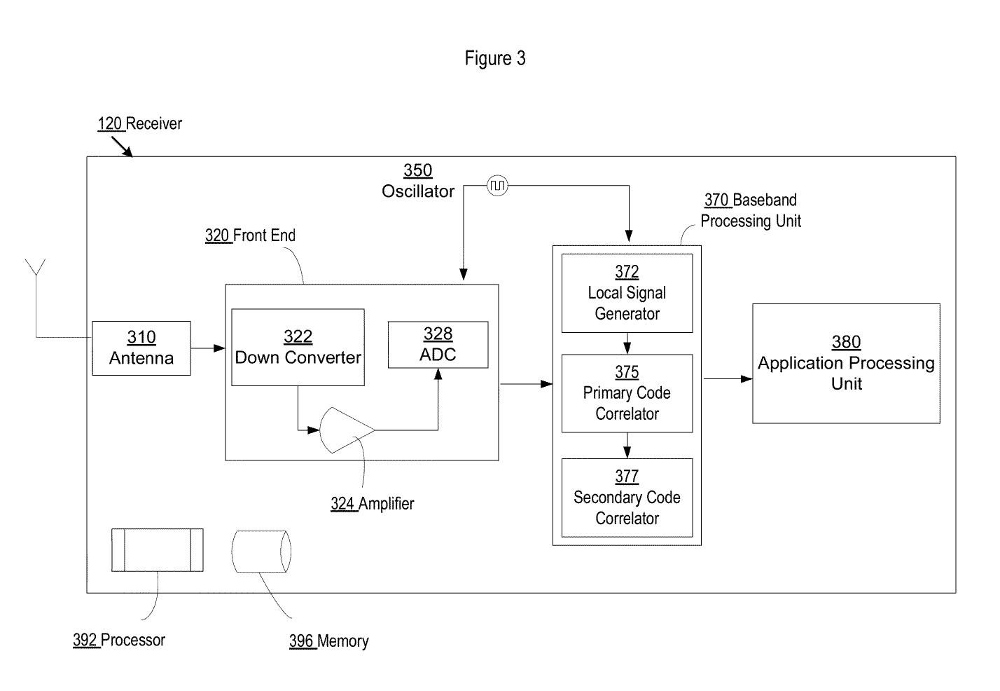

FIG. 3 illustrates an example receiver 120. The receiver 120 may include electronic circuitry to perform various operations. The circuitry may include one or more processors 392, such as signal processors, microprocessor and other such processors. The one or more processors may be capable of executing one or more computer executable instructions. The instructions may be stored in a memory 396 of the receiver 120, or accessible by the one or more processors 392 via a communication interface, such as a communication port (not shown).

The receiver 120 may further include an antenna 310, a front end 320, an oscillator 350, a baseband processing unit 370, and an application processing unit 380. The antenna 310 may receive the signal 150 as an analog radio frequency signal. The received signal 150 may be input to the front end 320. The analog signal may be down-converted, filtered, and digitized in the front end section 320. The front end 320 may include a down converter 322, an amplifier unit 324 and an analog to digital converter (ADC) 328 for the operations. The components of the front end 320 may be provided a clock signal from the oscillator 350, which functions as a local clock source of the receiver 120. The front end 320 generates a baseband representation of the signal 150 in a desired spectrum, such as an intermediate frequency (IF) spectrum, containing real and complex components, namely I (In-Phase) and Q (Quadrature) components, in baseband. The baseband representation may be forwarded to the baseband processing unit 370.

The baseband processing unit 370 is responsible for the signal processing tasks to be performed on the digital signal. The baseband processing unit may also be responsible for determining code delay and carrier phase and frequency measurements in order to obtain the data 180 in the received signal 150. Accordingly, the baseband processing unit 370 may have to identify a starting point and/or endpoint of the components of the received wireless signal 150. Although, the primary code 160 and secondary code 170 may have values that are known to the receiver 120, the codes may be continuously repeated during the transmission. The received wireless signal 150 may also have shifted in phase and/or frequency, relative to the originally transmitted wireless signal due to several factors. For example, Doppler effect (relative movement of the receiver with respect to the transmitter), environmental effects, interference with other signals, and other such factors may introduce a delay, or an offset which may, in turn, cause the received wireless signal 150 to be shifted relative to the transmitted signal. Further, the oscillator 350, or clock source may not be precisely synchronous with a clock source used by the transmitter 110, which may cause a phase offset between the received signal and generated local signals.

Once the baseband processing unit 370 determines the offsets, contents of the signal 150, may be forwarded on to the application processing unit 380. The application processing unit 380 may use the data 180 to provide navigation related information to a user, or to another system or device in communication with the receiver 120. For example, the data 180 may be used to provide a geographic location of the receiver 120, which may be displayed to the user via a display unit. Alternatively, or in addition, the geographic location may be transmitted to a separate system, or device, such as a server computer that may use the geographic location information to provide related information to the user. For example, the server computer may provide points of interest in the vicinity of the geographic location of the receiver 120. Various other applications of the navigation information contained within the data 180 are possible.

Therefore, the receiver 120, such as a GNSS receiver, using the baseband processing unit 370, may perform a synchronization operation, which may be part of a signal acquisition operation. FIG. 3 further illustrates example components of the baseband processing unit 370, particularly a local signal generator 372, a primary code correlator 375, and a secondary code correlator 377. The components may be used for the synchronization operation. The components of the baseband processing unit 370 may operate using the oscillator 350 as a clock source.

The baseband processing unit 370, using the primary code correlator 375, may correlate the incoming signal 150, in the baseband form provided by the front end 320, with a replica of the expected signal to extract the primary code 160. The local signal generator 372 may generate the replicas of the expected signal. The locally generated expected signal may include similar components as described with reference to FIGS. 1 and 2, such as a primary code, and a secondary code, values of which are known a priori. The primary code correlator 375 may synchronize the primary code 160 in the received signal and a locally generated expected signal, and extract information related to the primary code 160 using a despreading operation. To extract valid significance, or data from the correlation, the local replica generated in the receiver has to take into account the signal carrier frequency, code delay, Doppler frequency, the PRN, or primary code 160 (which is unique to each satellite/signal), and secondary code 170. The secondary code 170 may be unique to a satellite. Alternatively, satellites in a particular constellation, such as Galileo or Beidou, may share a secondary code 170.

As part of the synchronization operation, the secondary code correlator 377 may determine offsets associated with the received secondary code 170. The secondary code 170 may be associated with one or both of a frequency offset and a code offset. A ‘frequency offset’ refers to the frequency difference between the received secondary code 150 and a locally generated expected secondary code. ‘Code offset’ or ‘phase offset’ refers to the degree of time synchronization between the received secondary code 170 and the locally generated secondary code.

Therefore, the synchronization may further involve the search for signal energy over a multitude of hypothesized secondary code offsets, and a multitude of hypothesized frequency offsets applicable to the secondary code 170. This is typically visualized as a 2 dimensional search, with one dimension being frequency offset and the other dimension being code offset. Traditional approaches to secondary code synchronization in the presence of large frequency uncertainty involve computation of the energy associated with coherently and non-coherently integrated versions of the prompt correlator, or the primary code correlator output. The energy can be calculated over a two dimensional grid of secondary code phase offset and frequency offset hypotheses. The secondary code phase/frequency offset pair which results in the highest energy form the basis of estimates for secondary code phase and frequency offset, respectively. A full two-dimensional search over both secondary code phase as well as frequency offset may potentially be associated with excessive computational complexity. In addition, unless some additional processing is carried out, the quality of the frequency estimate is limited by the frequency hypothesis bin spacing. Also, secondary code phase estimation is degraded at frequency offsets relatively far from the nearest frequency bin hypotheses (for example, half way between adjacent frequency bin hypotheses).

However, the receiver 120 may determine the code offset and the frequency offset by a search over a single dimension, such as the secondary code offsets, thus determining the offsets in a more computationally efficient manner. The receiver 120 may achieve the efficiency by searching for secondary code phase offset in the secondary code chip transition domain. Compared to conventional techniques, the disclosed techniques described throughout this document and employed by the example receiver 120 may provide more accurate and resource-efficient secondary code phase synchronization and frequency estimation of signals, such as GNSS signals, in the presence of frequency uncertainty.

The primary code correlator 375 output at a k^{th} received Coarse Acquisition (C/A) epoch comprises of signal and noise component:

yₖ=sₖ+nₖ k∈Z₊ (1)

where Z₊ is the set of non-negative integers, sₖ is the signal and nₖ is the noise component.

The signal component may be further expressed as:

$${s}_{k} = {Ae}^{j ( ω k + θ )} {\sum }_{m = - ∞}^{∞} {b}_{m} {p}_{k + mN - φ} \\ {b}_{m} ∈ \{ - 1 , 1 \} {T}_{b} spaced BPSK symbols \\ {p}_{k} = \{ \begin{matrix}{c}_{k} & k ∈ \{ 0 , 1 , … , N - 1 \} \\ 0 & k ∉ \{ 0 , 1 , … , N - 1 \}\end{matrix} \\ {c}_{k} ∈ \{ - 1 , 1 \} {T}_{C / A } secondary c ode chips \\ N = \frac{{T}_{b}}{{T}_{C / A}} number secondary c ode chips per bit \\ φ ∈ \{ 0 , 1 , … , N - 1 \} secondary code offset \qquad ( 2 )$$

where A, ω, and θ are the signal amplitude, frequency (in radians per C/A epoch), and phase, respectively. In addition, T_{C/A} and T_{b} are the C/A epoch interval and bit interval, respectively, while N is the number of C/A epochs spanning a bit interval. Lastly, bₘ is the m^{th} transmitted BPSK symbol, p_{k is the k}^{th} sample of a secondary code chip modulated sequence of duration T_{b}, and φ is the bit phase offset.

The noise component, of Equation 1 may be further expressed as:

nₖ [symbol] CN(0, σ²) σ²=E[|nₖ−E[n_{k]|}²]=E[|nₖ|²]

Modeled as a realization of an independent, identically distributed (IID) sequence of circularly complex normal random variables of zero mean and variance δ², where E[•] denotes statistical expectation.

Given, the above mathematical expressions, determining the phase offset of the output of the primary code correlator 375 involves estimating the secondary codephase offset φ, given a length-K sequence {yₖ}ₖ₌₀^{K-1}.

A traditional two-dimensional search grid over N hypothesized secondary code phase offsets and Q hypothesized frequency offsets may be expressed as:

φ̅∈ Φ̅={ φ̅₀ φ̅₁ . . . φ̅_{N-1}} φ̅ᵢ=i (3)

ω̅∈ Ω̅={ ω̅₀ ω̅₁ . . . ω̅_{Q-1}} ω̅_{q}∈[−π, π)

Assuming that the received samples span an integer number of bits/secondary code repetitions: K=PN where P is an integer greater than one. Therefore, a merit function, that expresses the search that needs to be performed to determine the code phase offset, of the traditional two-dimensional approach, is:

$${M}_{\overline{φ} , \overline{ω}} = {\sum }_{p = 0}^{P - 2} {\vert {\sum }_{i = 0}^{N - 1} {c}_{i} {y}_{i + pN + \overline{φ}} {e}^{- j \overline{ω} i} \vert}^{2} \qquad ( 4 )$$

The arguments, \hat{φ}, \hat{ω}, which jointly maximize the merit function are deemed as the detected secondary code phase offset and estimated frequency offset, which is mathematically expressed as:

$$\hat{φ} , \hat{ω} = arg {max }_{\overline{φ} ∈ \overline{Φ} , \overline{ω} ∈ \overline{Ω}} \{ {M}_{\overline{φ} , \overline{ω}} \} \qquad ( 5 )$$

The receiver 120 may detect and determine the code phase offset and estimated frequency offset in a more efficient manner by searching a single dimension, unlike the two dimensional search expressed in the merit function of equation 5. The receiver 120 may determine the code phase offset and the estimated frequency offset by operating in the secondary code chip transition domain via complex conjugate products of the prompt correlator outputs coherently integrated to the C/A epoch. The complex conjugate product may be correlated against delayed versions of an appropriately defined reference sequence corresponding to the expected conjugate products in the absence of noise and frequency errors. Alternatively, delayed versions of the complex conjugate product may be correlated against an appropriately defined reference sequence corresponding to the expected conjugate products in the absence of noise and frequency errors. The complex conjugate products and/or the reference secondary code sequence may be delayed using delays that correspond to the different secondary code phase hypotheses. The correlation results are either a constructive or destructive summing according to the sign of corresponding chip transitions. The correlations may also be referred to as cross-correlations.

A magnitude of the resulting correlations may be computed. The magnitude may be the absolute value of the final chip transition domain correlation operation. The delay corresponding to the correlation with the largest magnitude may be used to estimate the secondary code phase offset. The phase associated with the correlation with largest magnitude may be used to estimate the frequency offset. Based on the identified cross-correlation, a one dimensional search over secondary code phase offsets may provide the code phase offset and the frequency offset of the secondary code. Moreover, frequency estimates may be generated with minimal additional computation, and with accuracy.

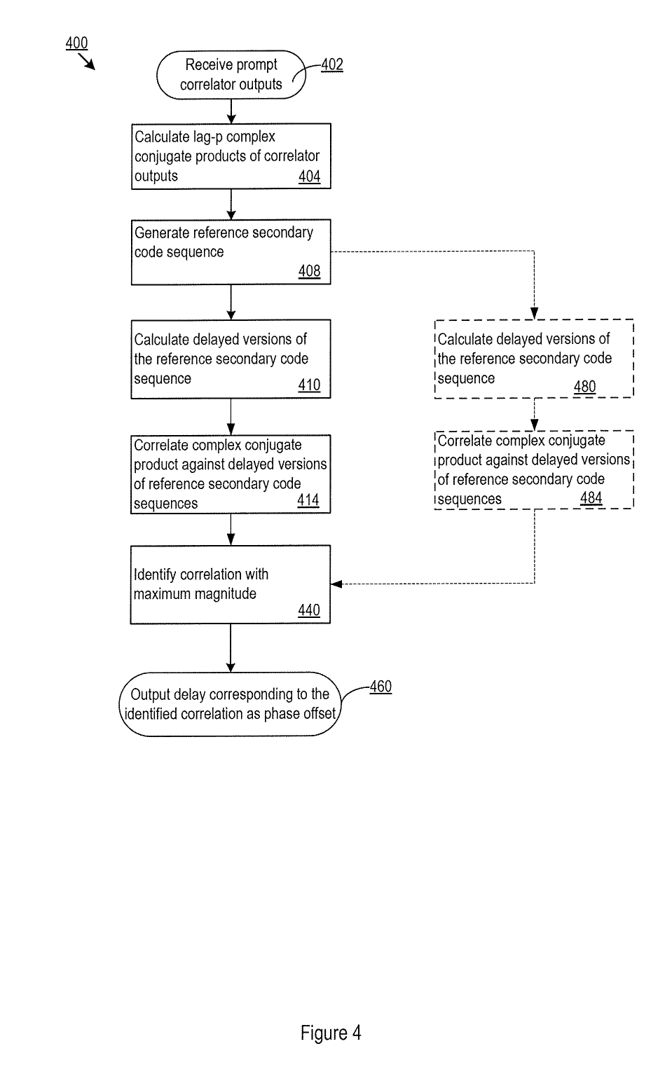

FIG. 4 illustrates an example flowchart with at least some of the steps involved in the detection of the code phase offset. The steps shown operate on outputs of the prompt correlators of the receiver 120 (402). For example, the receiver 120, using the baseband processing unit 377, may compute a lag-one conjugate product sequence of the secondary code component of the received signal 150 (404). Alternatively, a lag-p conjugate product sequence may be computed, such as lag-two, or lag-three. Thus, complex conjugate products of prompt correlator outputs coherently integrated to the C/A, or primary code epoch are formed. This may be expressed as:

lₖ=yₖ₊1y*ₖ k∈{0, 1, . . . , K−2} (6)

where, (.)* denotes complex conjugation.

Alternatively, in cases where a residual frequency offset is small, the real parts of the prompt correlator outputs may be integrated to the C/A as shown in equation 6A.

lₖ=Re{yₖ₊₁y*ₖ} k∈{0, 1, . . . , K−2} (6A)

Further, the receiver 120 may compute one or more reference secondary signal sequences (408). A reference secondary code sequence may be an N element lag-one secondary code chip product sequence. An example reference secondary code dₖ, may be expressed as:

dₖ=c₍ₖ₊₁₎mod N^{C*}ₖ k∈{0, 1, . . . , N−1}.

The generated reference signals may be correlated with delayed versions of the complex conjugate product (410, 414). For example, based on different hypotheses of the code phase offsets \hat{φ}, correlations of the generated reference signals and the delayed versions of the complex conjugates may be computed. A single dimensional merit function, representative of the operation may be expressed as:

$${V}_{\overline{φ}} = {\sum }_{i = 0}^{N - 1} {d}_{i} ( {\sum }_{p = 0}^{P - 2} {𝓁}_{i + pN + \overline{φ}} ) . \qquad ( 8 )$$

Alternatively, the hypothesized code phase offsets may be used to generate delayed versions of the reference code sequences represented by dₖ (480), and the merit function may involve correlations of the delayed versions of the reference secondary code sequence and the complex conjugate products of the prompt correlator outputs coherently integrated to the primary code epoch (484). For lag-one products, value of p in 404 may be 1. However, the receiver may form the merit function based on some combination of lag-p conjugate products, where p≧1.

A magnitude of the resulting correlations may be computed. The correlation with maximum magnitude may be identified (440). The delay associated with the maximum magnitude correlation may be used to determine the phase offset. For example, the associated delay may be output as the secondary code phase offset (460). The detected secondary code phase offset , may then be expressed as

$$\hat{φ} = arg {max}_{\overline{φ} ∈ \overline{Φ}} \vert {V}_{\overline{φ}} \vert \qquad ( 9 )$$

and, the frequency offset \hat{ω}, may be estimated with essentially no additional computation based on the resulting correlations. For example, the frequency offset may be computed as the arctangent of the correlation with the maximum amplitude:

\hat{ω}=∠(V_{\hat{φ}}). (10)

Alternatively, or in addition, the frequency offset may be calculated based on a weighted combination of multiple high peaks to estimate the frequency at those delays. For example, a subset of the resulting correlations may be selected to calculate the frequency offset. The subset may include a predetermined number of correlations. The correlations selected in the subset may be based on a predetermined magnitude threshold. For example, correlations above the predetermined magnitude threshold may be selected as the subset for determining the frequency offset. Alternatively, or in addition, other criteria to select the subset of correlations may be used.

In an example, the receiver 120 may excise the complex conjugate products straddling bit-boundaries by using a variation of the merit function, such as:

$${V}_{\overline{φ}} = {\sum }_{i = 0}^{N - 2} {d}_{i} ( {\sum }_{p = 0}^{P - 2} {𝓁}_{i + pN + \overline{φ}} ) . \qquad ( 11 )$$

The excising may avoid impact of data bit transitions at the true secondary code phase offset.

Thus, the receiver 120 may detect and determine the code phase offset and the frequency offset based on the complex conjugate product sequence and the one or more reference secondary code sequences, using a single dimension search.

The methods, devices, and logic described above may be implemented in circuitry in many different ways and in many different combinations of hardware, or both hardware and software. For example, all or parts of the system may include circuitry that includes a controller, a microprocessor, and/or an application specific integrated circuit (ASIC), or circuitry may be implemented with discrete logic or components, or a combination of other types of analog or digital circuits, combined on a single integrated circuit or distributed among multiple integrated circuits. All or part of the logic described above may be implemented as instructions for execution by circuitry that may include a processor, controller, or other processing device and may be stored in circuitry that includes a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may be circuitry that includes a storage medium and computer readable instructions stored on the medium, which when executed in an endpoint, computer system, or other device, cause the device to perform operations according to any of the description above.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be circuitry distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

We claim:

1. A method comprising:
receiving, using circuitry at a Global Navigation Satellite System (GNSS) receiver, a plurality of GNSS signals transmitted by a GNSS satellite, wherein a GNSS signal comprises a primary code sequence, a secondary code sequence, and a data portion;
extracting, using the circuitry, the secondary code sequence in each of the received GNSS signals;
analyzing, using the circuitry, the extracted secondary code sequence based on a plurality of reference secondary code sequences, wherein the reference secondary code sequences comprise delayed versions of a predetermined secondary code sequence;
identifying, using the circuitry, based on the analysis, the delay associated with a reference secondary code sequence from said plurality of reference secondary code sequences as a phase offset to be used for synchronizing the GNSS receiver with the GNSS satellite; and
outputting, using the circuitry, the phase offset to be used for synchronizing the GNSS receiver with the GNSS satellite.

2. The method of claim 1, wherein the plurality of received GNSS signals comprises a first GNSS signal and a second GNSS signal, and the method further comprises:
extracting, using the circuitry, a first secondary code sequence from the first GNSS signal and a second secondary code sequence from the second GNSS signal;
generating, using the circuitry, a complex conjugate of the second secondary code sequence; and
calculating, using the circuitry, a product of the first secondary code sequence and at least a part of the generated complex conjugate of the second secondary code sequence.

3. The method of claim 2, further comprising:
calculating, using the circuitry, a plurality of cross-correlations of the calculated product and each secondary code sequence of the plurality of reference secondary code sequences.

4. The method of claim 3, further comprising:
identifying, using the circuitry, a cross-correlation with a maximum magnitude value from the calculated cross-correlations; and
identifying, using the circuitry, the reference secondary code sequence associated with the identified cross-correlation with the maximum magnitude.

5. The method of claim 4, wherein the delay associated with said identified reference secondary code sequence as the phase offset to be used for said synchronization.

6. The method of claim 4, further comprising:
determining, using the circuitry, an angle associated with resulting sequence of the calculated correlation with the maximum result; and
outputting, using the circuitry, the determined angle as the frequency offset to be used for said synchronization of the GNSS receiver with the GNSS satellite.

7. The method of claim 6, wherein the angle is determined by calculating an arctangent of the resulting sequence of the calculated correlation with the maximum magnitude value.

8. The method of claim 6, wherein the angle is determined by calculating a weighted combination of a subset of the calculated cross-correlations, wherein the subset of the calculated cross-correlations includes the calculated cross-correlations with corresponding magnitudes above a predetermined threshold.

9. The method of claim 2, wherein the second GNSS signal is received after a predetermined delay since receipt of the first GNSS signal.

10. A wireless signal receiver comprising:
circuitry to receive wireless signals, each wireless signal comprising a spread spectrum signal comprising a periodic extension of a primary code, a periodic extension of a secondary code, and a data portion;
circuitry to determine, from a first received wireless signal, a first chip sequence representative of the secondary code by extraction of the primary code and the data portion from the first received wireless signal;
circuitry to determine, from a second received wireless signal, a second chip sequence representative of the secondary code by extraction of the primary code and the data portion from the second received wireless signal;
circuitry to identify a phase offset associated with the received wireless signals by analyzing the first chip sequence and the second chip sequence; and
circuitry to synchronize the wireless signal receiver with a transmitter of the received wireless signals using the identified phase offset.

11. The wireless signal receiver of claim 10, further comprising:
circuitry to calculate a complex conjugate product of the first chip sequence and the second chip sequence;
circuitry to calculate a plurality of cross-correlations of a reference chip sequence and a delayed version of the complex conjugate product, wherein the complex conjugate product is delayed by one of a plurality of predetermined delays; and
circuitry to identify a delay from the plurality of predetermined delays such that a magnitude of the cross-correlation calculated at the identified delay is the maximum among magnitudes of the calculated cross-correlations.

12. The wireless signal receiver of claim 11, further comprising circuitry to identify said delay as the phase offset for said synchronization.

13. The wireless signal receiver of claim 11, further comprising circuitry to determine a frequency offset used in the synchronization of the wireless signal receiver with the transmitter based on the calculated cross-correlations.

14. The wireless signal receiver of claim 13, wherein the phase offset and the frequency offset for the synchronization of the wireless signal receiver with the transmitter are determined without a search over a set of frequency offsets.

15. The wireless signal receiver of claim 10, wherein the first received wireless signal and the second received wireless signal are received sequentially.

16. A non-transitory computer storage medium comprising instructions executable by one or more processors, the instructions comprising:
instructions to receive a first signal and a second signal, wherein each signal comprises at least a periodic extension of a primary code, a data portion, and a periodic extension of a secondary code;
instructions to identify the secondary code sequence in the received first signal;
instructions to identify the secondary code sequence in the received second signal;
instructions to determine an offset associated with the received signals based on the identified secondary code sequences; and
instructions to synchronize a local clock source based on said offset.

17. The non-transitory computer storage medium of claim 16, further comprising:
instructions to calculate a complex conjugate product of the secondary code sequence in the received first signal and the secondary code sequence in the received second signal.

18. The non-transitory computer storage medium of claim 17, wherein the complex conjugate product is coherently integrated to the epoch of the primary code.

19. The non-transitory computer storage medium of claim 17, further comprising:
instructions to calculate correlations of the complex conjugate product with each reference signal of a set of predetermined reference signals;
instructions to calculate a magnitude of each of the correlations, and determine, as a phase offset, a delay associated with a predetermined reference signal from the set of predetermined reference signals, wherein the magnitude of said predetermined reference signal is the maximum among the calculated magnitudes; and
instructions to calculate the frequency offset based on a weighted combination of a subset of the correlations of the complex conjugate product with each reference signal of the set of predetermined reference signals, wherein the subset comprises a predetermined number of correlations.

20. The non-transitory computer storage medium of claim 17, wherein, the real components of the complex conjugate product are integrated to the epoch of the primary code.
